(19) United States
(12) Patent Application Publication
(10) Pub. No.: US 2009/0303988 A1
(43) Pub. Date: Dec. 10, 2009

(54) Communication System for Home Automation Using Advanced ADSL

(75) Inventors: Tong-Sok Kim, Seoul (KR); Suk-Hyun Shin, Seoul (KR); Ji-Young Choi, Seoul (KR); Byung-Ho Park, Seoul (KR); Se-Cheol Park, Seoul (KR)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: KT CORPORATION, Kyoungki-Do (KR)

(21) Appl. No.: 12/543,291

(22) Filed: Aug. 18, 2009

Related U.S. Application Data
(63) Continuation of application No. 10/529,564, filed on Nov. 2, 2005.

(30) Foreign Application Priority Data
Sep. 28, 2002 (KR) 10-2002-0059191

(51) Int. Cl. H04L 29/02; H04B 1/38; H04L 12/66

(52) U.S. Cl. 370/352; 375/222; 370/474

(57) ABSTRACT

Communication system for home automation using advanced asymmetric digital subscriber line (ADSL) is provided. Communication system for home automation using advanced ADSL includes: a home automation communication server means for providing home automation service; a home automation service channel means for interchanging data through wire or wireless line of baseband signal with object apparatus of home automation, the home automation service channel means included in ADSL terminal; and a home automation service multiplexing means for connecting the home automation communication server means and home automation service channel means through baseband signal, the home automation service multiplexing means included in ADSL connection apparatus.

### CROSS-REFERENCE TO RELATED APPLICATION

This is a continuation of U.S. Ser. No. 10/529,564, which is the U.S. national phase of PCT/KR2002/002482 filed Dec. 30, 2002, which in turn claims the priority of KR 2002-0059191 filed Sep. 28, 2002, the entire respective disclosures of which are incorporated herein by reference.

### TECHNICAL FIELD

The present invention relates to a communication system for home automation using advanced asynchronous digital subscriber line (ADSL).

### BACKGROUND ART

A home automation service provided by connecting a home network with a communication network is not in practical use. It is because a fixed Internet protocol (IP) address must be allocated to each home and it requires maintaining power-on a dedicated computer which is capable of handling protocols for Internet service such as a user datagram protocol (UDP), transmission control protocol (TCP)/IP or a simple network management protocol (SNMP).

Therefore, in a view of user, electric power is wasted to maintain turning on the dedicated computer using electric power of 350 W/h. Furthermore, in a view of service provider, IP resources are not effectively used because the fixed Internet protocol (IP) address is allocated to each home.

That is, it is not effective to use complicated routing procedure and the fixed IP address for providing the home automation service which can be provide by comparative simple address allocation.

In a conventional asynchronous digital subscriber line (ADSL), voice signals are transferred through a voice band and high speed signals including Internet data signals are transferred through a high frequency band by modulating the high speed signals in carrierless amplitude modulation (CAP) mode or discrete multitone (DMT) mode. A method for transferring various types of data by dividing an ADSL band into a low rate band and a high rate band is disclosed in Korean patent application No. 2000-0281576 entitled “Asynchronous Digital Subscriber Line (ADSL) transceiver unit using Dual Link Discrete Multi Tone (DLDMT).” Low speed data can be transferred by using 4 lines of the low rate band at 64 Kbps and high speed digital data can be transferred by using the high rate band at 6 Mbps within 4 km.

By using the DLDMT ADSL for the home automation service, the home automation service can be easily used and the above mentioned problems of inefficient use of fixed IP address and high energy consumption can be eliminated. However, the DLDMT ADSL has not been developed yet.

The ADSL is a technology to access data network by using a telephone network. It is predicted as remarkable technology for providing various forms of digital communication services in near future. As a goal of application of ADSL, at first, high speed Internet service is provided by providing Ethernet port as like as the conventional ADSL. Secondly, voice signals are transferred in a digital mode by adding a digital voice channel and digitalizing a subscriber's network. Finally, a communication service for home automation in order to connect the home network with the communication network of communication companies by adding a home automation channel in the ADSL.

However, communication companies currently provides only high speed Internet service as ADSL service and the development of the digital voice channel using the DLDMT and a voice over digital subscriber line (VoDSL) of ADSL forum is in progress.

Also, in order to provide a home automation communication service, digital communication channels between the subscribers and the communication companies are required and a message communication structure for associating a home automation terminal and a home automation communication server is necessary.

### DISCLOSURE OF THE INVENTION

It is, therefore, an object of the present invention to provide a home automation system using advanced asynchronous digital subscriber line (ADSL) for remotely accessing and controlling home automation devices through the Internet or a telephone network; and, particularly, to a home automation system using advanced ADSL for transferring ADSL signal with a home automation channel, identifying home networks by using a telephone number and providing application services.

In accordance with an aspect of the present invention, there is provided a home automation communication system using advanced asymmetric digital subscriber line (ADSL), including: a home automation communication server for providing a home automation service; a home automation service channel unit included in an ADSL terminal for transmitting/receiving data with home automation devices in wired or wireless communication mode using low rate signals; and a home automation multiplexing unit included in an ADSL accessing unit for multiplexing data between the home communication server and the home automation service channel unit.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a communication system for a home automation service using dual link discrete multi-tone (DLDMT) in advanced asymmetric digital subscriber line (ADSL) in accordance with a preferred embodiment of the present invention;

FIG. 2 is a block diagram showing a communication system for a home automation service using asynchronous transfer mode (ATM) in advanced ADSL in accordance with a preferred embodiment of the present invention;

FIG. 3 is a block diagram showing a home automation service (HAS) channel module of an ADSL terminal in a home automation communication system using the advanced ADSL in accordance with the present invention;

FIG. 4 is a block diagram showing an ADSL accessing unit and a home automation communication server of the ADSL terminal in the home automation communication system using the advanced ADSL in accordance with the present invention;

FIG. 5 is a block diagram showing a protocol message format of the HAS and HAS information fields of the ADSL terminal in the home automation communication system using the advanced ADSL in accordance with the present invention; and

FIG. 6 is a flowchart showing a method of a home automation communication service using the advanced ADSL in accordance with the present invention.

### BEST MODE FOR CARRYING OUT THE INVENTION

Other objects and aspects of the invention will become apparent from the following description of the embodiments with reference to the accompanying drawings, which is set forth hereinafter.

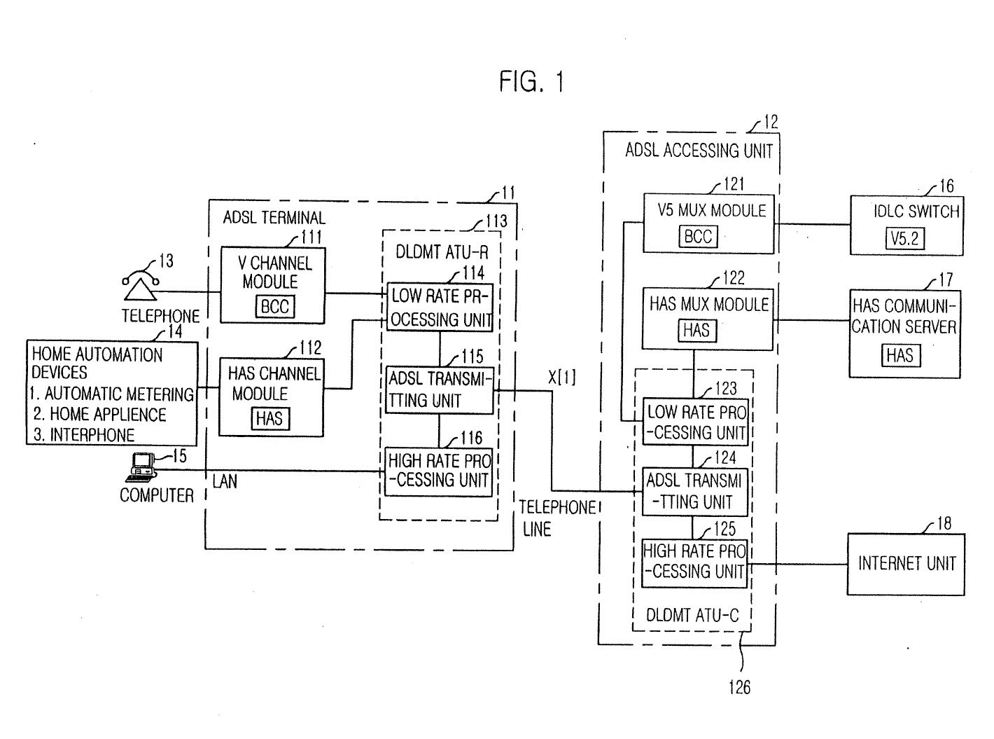

FIG. 1 is a block diagram showing a communication system for a home automation service using dual link discrete multi-tone (DLDMT) in advanced asymmetric digital subscriber line (ADSL) in accordance with a preferred embodiment of the present invention.

In the DLDMT ADSL, output signal X[n] is a sum of {aₖ} signals and {bₖ} signals. Low rate signals are transmitted based on {aₖ} signals and high rate signals are transmitted based on {bₖ} signals. The above mentioned concept is defined in following equations as:

$$X [ n ] = {\sum }_{k = 0}^{r - 1} 1 / \sqrt{N} {a}_{k} exp ( j k 2 π / Nn ) + {\sum }_{k = r}^{n - 1} 1 / \sqrt{N} {b}_{k} exp ( j k 2 π / Nn ) \\ {a}_{k} = 1 / \sqrt{N} {\sum }_{k = ≺ N ≻}^{ } X [ n ] exp ( - j k 2 π / Nn ) , 0 \leq k \leq r - 1 \\ {b}_{k} = 1 / \sqrt{N} {\sum }_{k = ≺ N ≻}^{ } X [ n ] exp ( - j k 2 π / Nn ) , r \leq k \leq n - 1. \qquad Eq . ( 1 )$$

A low rate processing unit of the DLDMT receives a home automation service (HAS) channel signal, maps the HAS channel signals into {aₖ} signals and transfers the {aₖ} signals to an inverse discrete Fourier transform (IDFT) unit. An ADSL access unit having HAS-MUX transfers a HAS protocol message of a ADSL termination unit-remote (ATU-R) to a home automation server through a V5 interface.

In more detail, the DLDMT low rate processing unit adds home automation data in a V5 message format into a common signaling channel (CSC) so as to transfer data for controlling home automation system and providing application service data in a HAS format. For a service requiring additional clear channel, a low rate frame is formed by allocating at most 4 “Vch” channels at 64 kbps, which are clear channels. Data for service requiring additional clear channel are mapped into the {aₖ} signals and transferred to the IDFT unit of the ADSL transferring unit. For providing the service, the HAS channel module is added to an ADSL terminal. For transferring data for controlling home automation system and providing application service, the HAS-MUX module is added to the ADSL accessing unit and home automation communication server is connected to the ADSL accessing unit. Furthermore, the home automation message is processed by using HAS protocol.

Referring to FIG. 1, the communication system for home automation using the DLDMT in the advanced ADSL includes a user block and a service provider block.

The user block includes an ADSL terminal 11, a telephone 13, a home automation equipment 14 and a computer 15. The service provider block includes an ADSL access unit 12, an integrated digital loop carrier (IDLC) switch 16, a home automation service (HAS) communication server 17 and an Internet unit 18.

Referring to FIG. 1, the home automation equipments 14 are connected to the home automation server 17 through the HAS channel module 112 in the ADSL terminal 11 and through the HAS-MUX module 122 in the ADSL accessing unit 12 in accordance with the present invention.

The ADSL terminal 11 includes a V channel module 111 for transferring voice signals back and forth between the telephone 13 and the DLDMT ATU-R 113, a HAS channel module 112 for transferring HAS control signals back and forth between the home automation equipments 14 and the DLDMT ATU-R 113, and a DLDMT ATU-R 113 for communicating with the ADSL accessing unit 12 using an ADSL transmitting unit 115, connecting the telephone 13 and the home automation equipments 14 through the low rate processing unit 114 and connecting the computer 15 through a high rate processing unit 116 and a local area network (LAN).

The DLDMT ATU-R 113 includes a low rate processing unit 114 for processing low rate signals to and from the V channel module 111 and the HAS channel module 112, an ADSL transmitting unit 115 for connecting the ADSL accessing unit 12 and a high rate processing unit 116 for processing the signals to and from the computer 15 through the LAN.

The ADSL accessing unit 12 includes a V5 MUX module 121 that is connected to the IDLC switch 16 for processing voice signals, a HAS MUX module 122 that is connected to the home automation server 17 for processing HAS control signals, and a DLDMT ATU-C 126 that is connected to the Internet unit 18 and the ADSL terminal 11 for processing the low rate signals by using the V5-MUX module 121 and the HAS MUX module 122 and processing the high rate signals.

Particularly, the ADSL accessing unit 12 multiplexes the ADSL signal to the IDLC switch 16, the HAS communication server 17 and the Internet unit 18.

The DLDMT ATU-C 126 includes a low rate processing unit 123 that is connected to the V5 MUX module 121 and the HAS MUX module 122 for processing low rate signals, an ADSL transmitting unit 124 for accessing the ADSL terminal 11 and a high rate processing unit 125 that is connected to the Internet unit for processing high rate signals.

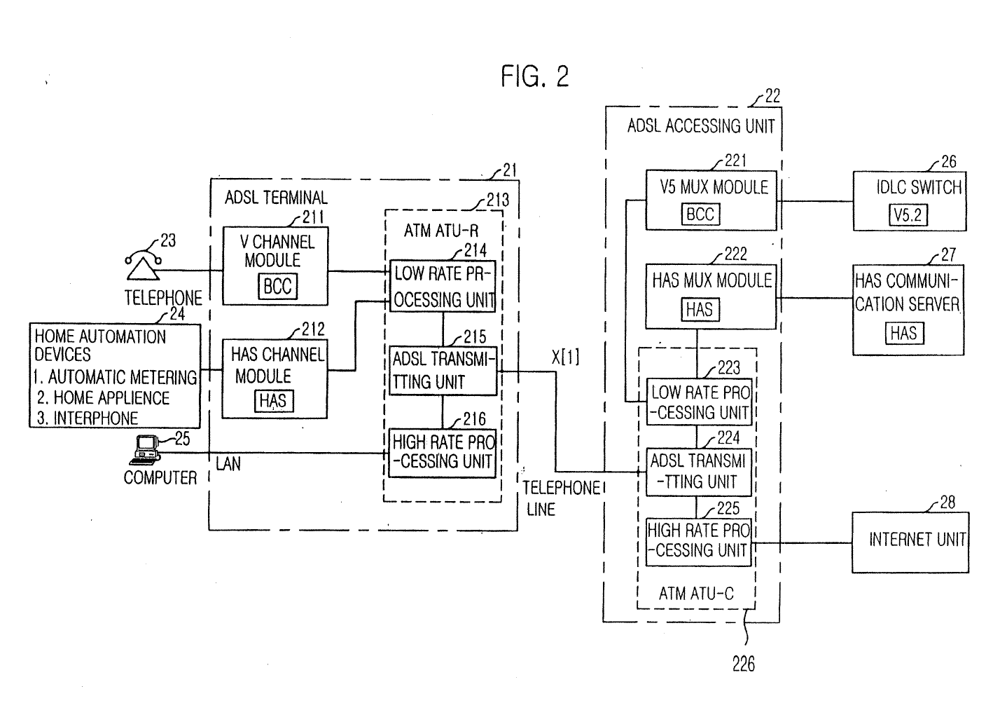

FIG. 2 is a block diagram showing a communication system for home automation using asynchronous transfer mode (ATM) in advanced ADSL in accordance with a preferred embodiment of the present invention.

An ATM high rate processing unit 216 provides a high-data-rate Ethernet accessing port. An ATM low rate processing unit 214 packetizes home automation data in the V5 message format into common signaling channel (CSC) in low rate frames, generates low rate frames by allocating at most 4 “Vch” channels for a service that requires 64 Kbps clear channel, packs 53 byte-long ATM cell, allows virtual channel identifier (VCI)/virtual path identifier (VPI) to ATM cells and transfers the ATM cells to an ATM transmission convergence (ATM-TC).

The ATM TC also transfers the ATM cells to the low rate processing unit or the high rate processing unit by using the VCIs/VPIs. An inverse discrete fourier (IDFT)/discrete fourier transform (DFT) unit of the ADSL transmitting unit receives the ATM cells from the ATM-TC and transfers the ATM cells to the IDFT/DFT unit of a corresponding ADSL transmitting unit. The low rate processing unit of ATM extracts data layer signals from the ATM cell or packs the data layer signals into the ATM cell. The high rate processing unit of ATM extracts Internet layer signals from the ATM cell or packs the Internet layer signals into the ATM cell.

Referring to FIG. 2, the communication system for the home automation service using ATM in advanced ADSL has a user block and a service provider block. The user block includes an ADSL terminal 21, a telephone 23, a home automation equipments 24 and a computer 25. The service provider block includes an ADSL access unit, an integrated digital loop carrier (IDLC) switch 26, a home automation service (HAS) communication server 27 and an Internet unit 28.

Referring to FIG. 2, the home automation equipments 24 are connected to the (HAS) communication server 27 through the HAS channel module 212 in the ADSL terminal 21 and through the HAS-MUX module 222 in the ADSL accessing unit 22 in accordance with the present invention.

The ADSL terminal 21 includes a V channel module 211 for transferring voice signals back and forth between the telephone 23 and the ATM ATU-R 213, a HAS channel module 212 for transferring HAS control signals back and forth between the home automation equipments 14 and the ATM ATU-R 213, and a ATM ATU-R 213 for communicating with the ADSL accessing unit 22 using an ADSL transmitting unit 215, connecting the telephone 23 and the home automation equipments 24 through the low rate processing unit 214 and connecting the computer 25 through a high rate processing unit 216 and a LAN.

The ATM ATU-R 213 includes a low rate processing unit 214 for processing low rate signals to and from the V channel module 211 and the HAS channel module 212, ADSL transmitting unit 215 for connecting the ADSL accessing unit 22 and a high rate processing unit 216 for processing the signals to and from the computer 25 through the LAN.

The ADSL accessing unit 22 includes a V5 MUX module 221 that is connected to the IDLC switch 26 for processing voice signals, a HAS MUX module 222 that is connected to the home automation server 27 for processing HAS control signals, and a ATM ATU-C 226 that is connected to the Internet unit 28 and the ADSL terminal 21 for processing the low rate signals by using the V5 MUX module 221 and the HAS MUX module 222 and for processing the high rate signals by using the Internet unit.

Particularly, the ADSL accessing unit 22 multiplexes the ADSL signals to the IDLC switch 26, the HAS communication server 27 and the Internet unit 28.

The ATM ATU-C 226 includes a low rate processing unit 223 that is connected to the V5 MUX module 221 and the HAS MUX module 222 for processing low rate signals, an ADSL transmitting unit 224 for accessing the ADSL terminal 21 and a high rate processing unit 225 that is connected to the Internet unit for processing high rate signals.

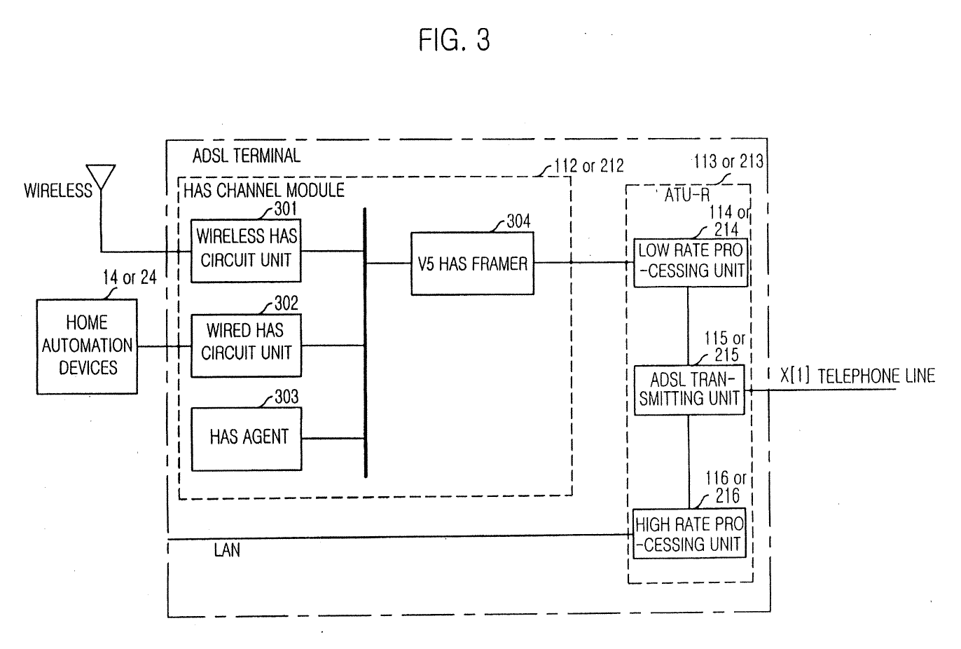

FIG. 3 is a block diagram showing a HAS channel module of the ADSL terminal in a home automation communication system using advanced ADSL in accordance with the present invention.

The HAS channel module 112 or 212 of ADSL terminal in a home automation communication system using advanced ADSL includes a wireless HAS circuit 301, a wired HAS circuit 302, a HAS agent 303 and a HAS framer 304.

The wireless HAS circuit 301 functions as a wireless home network and a wireless home automation interface. The wireless HAS circuit 301 sends and receives wireless data over the air, extracts a message from the wireless data and transfers the message to the HAS agent 302. Then, the HAS agent 303 controls the service based on home automation protocol and transfers the wireless data to the HAS framer 304. The wireless HAS circuit 301 may use infrared rays for interfacing a television or an air-conditioner, use radio frequencies or Bluetooth technology for home networking and use ultra wideband (UWB) technology that has an advantage of reducing a size of the circuit for a wideband service.

The wired HAS circuit 302 functions as wired home network and a wired home automation interface. The wired HAS circuit 302 sends and receives contents or control signals, and transfers the contents or the control signals to the HAS agent 303. Then, the HAS agent controls the service using home automation protocol and transfers the data to the HAS framer 304. The wired HAS circuit 302 may use a RS232 for controlling home appliances, use an Ethernet for home network, use an optical transmission for a broadband service and use a universal serial bus (USB) for personal computer devices.

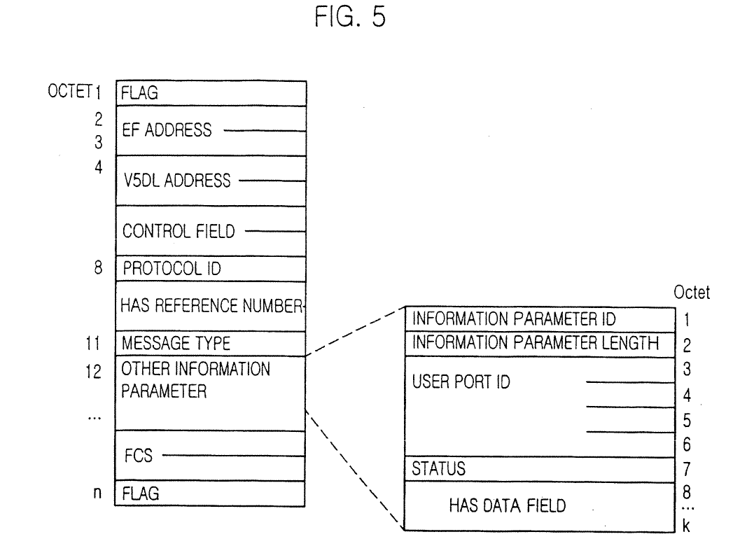

The HAS agent 303 receives messages and information from the HAS framer 304, executes a corresponding program and transfers home automation data to the wireless HAS circuit 301 and the wired HAS circuit 302. Also, the HAS agent 303 receives home automation data from the wireless HAS circuit 301 and the wired HAS circuit 302, analyzes the home automation data and transfers data to be transferred to the home automation communication server to the HAS framer 304 according to an information format included in the HAS message format shown in FIG. 5.

The HAS framer 304 forms a HAS message format or extracts a message type and information from the HAS message format. Also, the HAS framer 304 is coupled to the low rate processing unit of ATU-R and sends the HAS message to the low rate processing unit.

The low rate processing units 114 and 123 of the DLDMT ATU-R and the low rate processing units 214 and 223 of the ATM ATU-R are coupled to the HAS framer 304 by adding interface having 32 time slot and a speed of 2.048 Mbps.

The low rate processing unit 114 of the DLDMT ATU-R maps at most 4 home automation message frame signals at 64 Kbps into low rate signals of DLDMT. Reversely, the low rate processing unit 114 extracts the home automation messages from the low rate signals and transfers the messages to the HAS channel module 112.

The low rate processing unit 214 of the ATM ATU-R 213 packs at most 4 home automation message frame signals at 64 Kbps into ATM cell packet, allocates VCI/VPI numbers for a home automation communication system and transfers the packet to the ADSL transmitting unit 215. Reversely, the low rate processing unit 214 extracts the home automation messages from the ATM cell and transfers the messages to the HAS channel module 212.

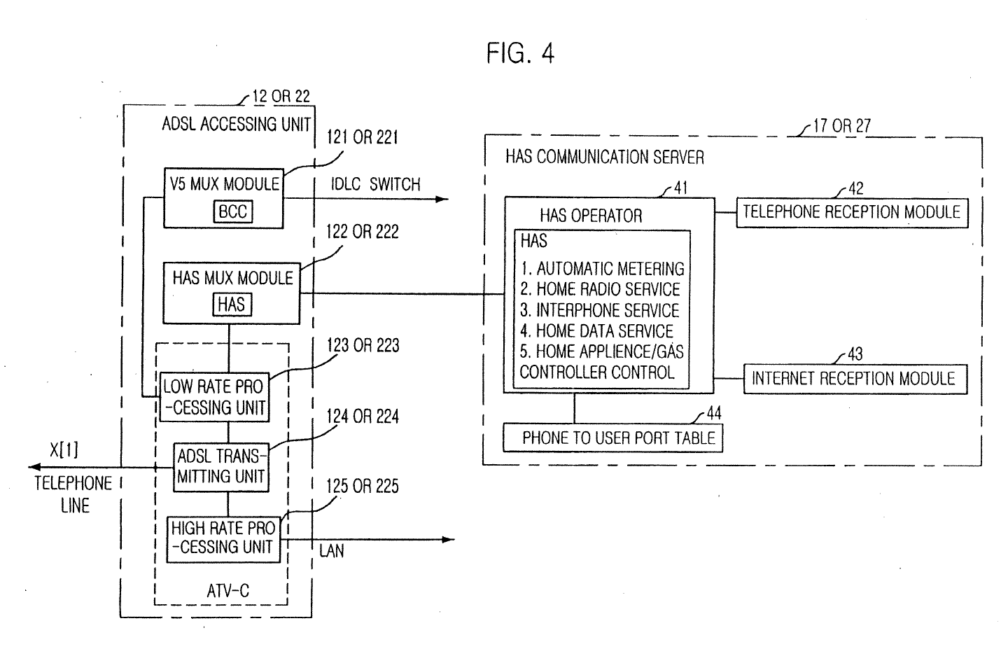

FIG. 4 is a block diagram showing an ADSL accessing unit and a home automation communication server of the ADSL terminal in a home automation communication system using advanced ADSL in accordance with the present invention.

The HAS MUX module 122 or 222 transfers a home automation message frame to the home automation communication server 17 or 27 through V5.1 at 2.048 Mbps, V5.2 or high speed Ethernet. Also, the HAS MUX module 122 or 222 receives the home automation message frame from the home automation communication server 17 or 27 through V5.1, V5.2 or high speed Ethernet.

The HAS-MUX module 122 or 222 includes a low rate frame accessing unit and a HAS processing unit. The low rate frame accessing unit is coupled with the low rate processing unit 123 or 223 of the DLDMT ATU-C 126 and the ATM ATU-C 226. The HAS processing unit transmits/receives the messages in message format shown in FIG. 5 with the HAS communication server 17 or 27 or the HAS channel module 112 or 212 of the ADSL terminal 11 or 21 through the low rate processing unit or the ADSL transmitting unit by performing HAS process.

The HAS communication server 17 or 27 receives a HAS and manages a database that contains phone numbers of subscribers, user port numbers of the ADSL terminals 11 or 21 and service profiles of subscribers. Also, the home automation communication server 17 or 27 provides interface to contents providers.

The home automation communication server 17 or 27 includes a HAS management unit 41, a phone reception module 42, an Internet reception module 43 and a phone to user port table 44.

The phone reception module 42 provides voice information of a home automation service and interfaces DTMF button input in case the user uses the phone for home automation service. The Internet reception module provides a graphic user interface (GUI) for a home automation service on the Internet.

The HAS management unit 41 manages home automation service in the home automation communication server 17 or 27 based on home automation protocol corresponding to the HAS agent 303.

The phone to user port table 44 generates and manages user port identification (ID). A size of the user port ID is 4 octets. The user port ID identifies the ADSL terminal 11 or 21 according to a phone number.

FIG. 5 is a block diagram showing a protocol message format of HAS and HAS information fields of ADSL terminal in a home automation communication system using advanced ADSL in accordance with the present invention.

A structure of the HAS protocol message is a modified version of V 5.2 interface BCC protocol and is applied to all V5 protocol messages in common.

Referring to FIG. 5, first and last octets are flags showing start and end of V5 envelope function (V5EF) frame. Second/third octets and third/forth octets are V5 data link address having protocol addresses as “11111000.” An eighth octet is a protocol identifier having an identification number of V5EF protocol as “0100100.” Control fields of sixth/seventh octets and frame check sequences (FCS) of n−1^{th}/n−2^{th} octets comes from link access procedure for the ISDN D channel (LAPD) protocol standard. Ninth/tenth octets are HAS reference numbers of each message and effective until a process of the message is completed.

An eleventh octet is a message type field. The message type field allows message identification numbers for requesting and responding to control a home automation service, searching home automation data, transferring data, reporting status of service, automatic metering, home radio and home data service. The HAS protocol agent of the ADSL terminal transfers data to the home automation devices in a recognizable format according to the message type field.

Other information parameter fields contain parameters for processing messages and data for application service.

Referring to FIG. 5, the other information fields include information parameter identification (ID), a length of information parameter, a user port ID, a status field and HAS data field. The information parameter ID identifies home automation service information among other V5EF information parameters. The length of information parameter shows a size of HAS information parameter in octet and is more than 8 octets. The user port ID identifies ADSL terminal and 4 octets. The status field shows status of port that is identified by the user port ID and operation information, e.g., calling, disabled, not using, call processing, testing and allocating/clearing of time slot for 63 Kbps clear channel.

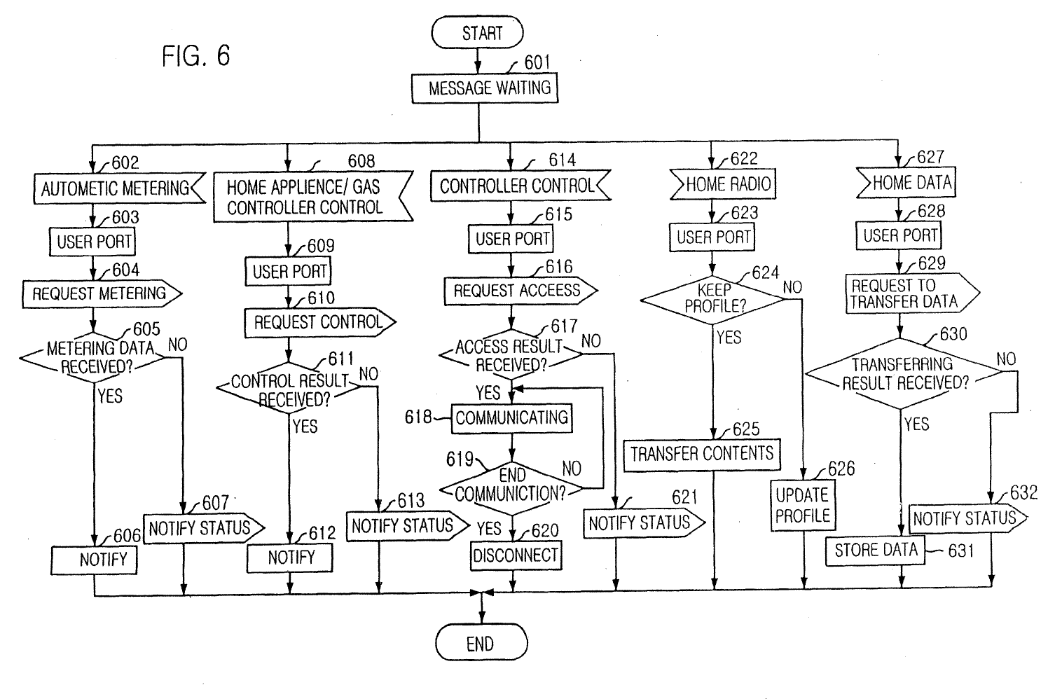

FIG. 6 is a flowchart showing a method of a home automation communication service using advanced ADSL in accordance with the present invention.

At step 601, the HAS protocol message is received. If a home automation service message is received, a corresponding process is performed by scanning a message type field and HAS information is transferred to the corresponding process.

A person, an electricity/gas company or contents provider accesses to the home automation communication server through the phone or the Internet, chooses a desired service and gives a phone number of a subscriber. Then, the home automation communication server transforms the phone number into a user port number and transfers the user port number in the HAS message format to the ADSL terminal.

The ADSL terminal receives the HAS message, performs a service of the automatic metering, the home radio or interphone communication according to an operation instruction and a parameter. Then, the ADSL terminal transfers result data to the home automation communication server.

If automatic metering is requested through the phone or the Internet at step 602, at step 603, the user port number for home automation is identified by using the phone number. At step 604, an automatic metering request message in HAS message format is transferred to the ADSL terminal. At step 605, it is determined whether the ADSL terminal received data for automatic metering.

At steps 606, wired or wireless data signal for automatic metering is generated and at step 607, the ADSL terminal transfers the result to the home automation communication server.

If it is requested to control a home appliance or a gas controller through the phone or the Internet at step 608, at step 609, the user port number for home automation is identified by using the phone number. At step 610, a message for controlling the home appliance or the gas controller in HAS message format is transferred to the ADSL terminal. Parameters for locking a gas valve, operating an air-conditioner, controlling a heater, controlling a television or controlling an electric rice cooker are included in the other information parameter field. At step 611, it is determined whether the ADSL terminal received data for controlling the home appliance or the gas controller. At steps 612, wired or wireless data signal for controlling the home appliance or the gas controller is generated and at step 613, the ADSL terminal transfers the result to the home automation communication server.

A video interphone is a device that closes or opens a door by identifying a visitor through a video interphone terminal installed near the door. The video interphone also has a function as an interphone providing connection of voice extension lines in the same apartment building. The wired HAS circuit unit or the wireless circuit unit of the ADSL terminal is coupled to the video interphone. Voice or video communication is available between the video interphone and the phone, between the video interphone and the Internet or between the video interphone and the video interphone. A number for identifying the video interphone is generated by using the phone number. A video interphone communication request message including the user port number and the phone number is transferred to the ADSL terminal.

If interphone communication is requested through the phone or the Internet at step 614, at step 615, the user port number for home automation is identified by using the phone number. At step 616, an access is requested. If the access is denied at step 617, the status of denying is notified. If the interphone is accessed at step 617, at steps 618, 619 and 620, communication through the interphone starts and ends.

The number of MP3 users is increasing due to advanced Internet technology and the number of digital radio channels is increasing because it is easy to build a digital music broadcasting station. The home radio service module of the home automation communication server manages subscriber profiles and contents, and transfers contents in the subscriber profiles to the ADSL terminal. The ADSL terminal generates indoor wireless broadcasting signal through the wireless HAS circuit unit. The wireless broadcasting technology may use the Bluetooth, the home radio frequencies or the wireless UWB. The home radio is a bi-directional transceiver and transfers music or contents in a home automation message format to the home automation communication server through the home communication channel. Then, the home automation communication server stores the music or contents in the user profile and delivers the result to the ADSL terminal by searching the contents.

If the home radio is requested through the phone or the Internet at step 622, at step 623, the user port number for home automation is identified by using the phone number. At step 624, it is determined whether profile is going to be updated. At step 625, the profile is transferred or at step 626, the profile is updated.

The home data service is a procedure for reading or writing data to a memory or auxiliary memory in the ADSL terminal and the wired or wireless HAS circuit unit.

The subscriber can upload or download files, messages or software using the fixed Internet protocol (IP). The ADSL terminal can download latest software for the HAS service and the home automation communication server executes remote upgrade. The ADSL terminal reports data required to manage the home data service in the HAS protocol message format to the home automation communication server.

Read/write instructions are performed according to the HAS protocol in order to use the memory or the auxiliary memory of the ADSL terminal as a file server.

The method of the present invention can be saved in a computer readable medium, e.g., a CD-ROM, a RAM, a ROM, a floppy disk, a hard disk, and an optical/magnetic disk.

As mentioned above, the present invention can use ADSL technology as digital voice channel, digital home automation communication channel and high speed Internet channel.

Also, the present invention can easily provide services such as automatic metering, home appliance/gas control, video interphone communication, home radio and home data service.

While the present invention has been described with respect to certain preferred embodiments, it will be apparent to those skilled in the art that various changes and modifications may be made without departing from the scope of the invention as defined in the following claims.

1. A home automation communication system using advanced asymmetric digital subscriber line (ADSL), comprising:
a home automation service communication server for providing a home automation service (HAS);
a home automation service channel means included in an ADSL terminal for transmitting/receiving a home automation service control signal and data with home automation devices in wired or wireless communication mode using ADSL low rate signals; and
a home automation multiplexing means included in an ADSL accessing means for multiplexing home automation service control signal and data between the home automation service communication server and the home automation service channel means.

2. The system as recited in claim 1, wherein the home automation service channel means includes:
a wireless home automation service means for performing functions of a wireless home network and a wireless home automation interface;
a wired home automation service means for performing functions of a wired home network and a wired home automation interface;
a home automation service framer connected to a low rate processing unit of ADSL termination unit-remote (ATU-R) for generating data having a home automation service message format based on message types and information parameters and transferring the data to the low rate processing unit and extracting a message type and information parameter from data having home automation service message format received from the low rate processing unit; and
a home automation service agent for receiving the messages and information parameter from the home automation service framer, performing a home service process and transferring the home automation service control signal and data to the wireless home automation service means and the wired home automation service means.

3. The system as recited in claim 1, wherein the home automation service multiplexing means includes:
a low rate frame accessing means connected to a low rate processing unit of ADSL termination unit-central (ATU-C) for receiving and transferring low rate data; and
a home automation service processing means connected to the home automation service communication server for performing home automation service process and transmitting/receiving home automation service control signal and data with the home automation service channel means through the low rate frame accessing means.

4. The system as recited in claim 1, wherein the advanced ADSL includes a dual link discrete multitone (DLDMT) method.

5. The system as recited in claim 1, wherein the advanced ADSL includes an asynchronous transfer mode (ATM).

6. The system as recited in claim 1, wherein home automation protocol message used for transferring information for the home automation service, includes:
flag fields which are first and last octets for showing start and end of V5 envelope function (V5EF) frame;
V5 data link address fields which are second/third octets and third/forth octets, wherein the second/third octets and third/forth octets are identically copied;
a protocol identifier field which is an eighth octet;
control fields which are sixth and seventh octets;
frame check sequence (FCS) fields in which n−1^{st} and n−2^{nd} octets are generated based on a link access procedure for Integrated Services Digital Network (ISDN) D channel (Link Access Protocol D-channel (LAPD)) protocol standard;
home automation service reference number fields which are ninth and tenth octets, wherein the home automation service reference number field is effective until a process of the message is completed;
a message type field for allocating message identification numbers for requesting and responding to control a home automation service, searching home automation data, transferring data, reporting status of service, automatic metering, home radio and home data service; and
information parameter fields for storing parameters for processing messages and data for application service.

7. The system as recited in claim 6, wherein the information parameter fields include:
an information parameter identification (ID) for identifying home automation service information among other V5EF information parameters;
a length of information parameter field for showing a size of home automation service information parameter in octet;
a user port ID field for identifying ADSL terminal, wherein a size of the user port ID field is 4 octets and the user port ID field is corresponding to a phone number of a subscriber; and
a status field for showing status of port that is identified by the user port ID and operation information, e.g., calling, disabled, not using, call processing, testing and allocating/clearing of time slot for 64 Kbps clear channel.

8. A home automation communication system using advanced asymmetric digital subscriber line (ADSL), comprising:
a home automation service communication server to provide a home automation service (HAS);
a home automation service channel module included in an ADSL terminal to transmit and receive a home automation service control signal and data with home automation devices in a wired or wireless communication mode using low rate signals; and
a home automation multiplexer included in an ADSL accessing unit to multiplex the home automation service control and data between the home automation service communication server and the home automation service channel module.

9. The system as recited in claim 8, wherein the home automation service channel module includes:
a wireless home automation service circuit to perform functions of a wireless home network and a wireless home automation interface;
a wired home automation service circuit to perform functions of a wired home network and a wired home automation interface;
a home automation service framer connected to a low rate processing unit of an ADSL termination unit-remote (ATU-R) to generate data having a home automation service message format based on message types and information parameters and to transfer the data to the low rate processing unit and extract a message type and information parameter from data having home automation service message format from received the low rate processing unit; and
a home automation service agent to receive messages and information parameter from the home automation service framer, to perform a home service procedure, and to transfer the home automation service control signal and data to the wireless HAS circuit and the wired home automation service circuit.

10. The system as recited in claim 8, wherein the home automation service multiplexer includes:
a low rate frame accessing unit connected to a low rate processing unit of an ADSL termination unit-central (ATU-C) to receive and transfer low rate data; and
a home automation service processing unit connected to the home automation service communication server to perform a home automation service procedure and to transmit and receive the home automation service control signal and data with the home automation service channel module through the low rate frame accessing unit.

11. The system as recited in claims 8, wherein the advanced ADSL includes a dual link discrete multi-tone (DLDMT) method.

12. The system as recited in any one of claims 8, wherein the advanced ADSL includes an asynchronous transfer mode (ATM).

13. The system as recited in claim 8, wherein a home automation protocol message used to transfer information to the home automation service channel module, includes:
flag fields which are first and last octets to show a start and an end of a V5 envelope function (V5EF) frame;
V5 data link address fields which are second/third octets and third/forth octets, wherein the second/third octets and third/forth octets are identically copied;
a protocol identifier field which is an eighth octet;
control fields which are sixth and seventh octets;
frame check sequence (FCS) fields in which n−1^{st} and n−2^{nd} octets are generated based on a link access procedure for the Integrated Services Digital Network (ISDN) D channel (Link Access Protocol Channel-D (LAPD)) protocol standard;
home automation service reference number fields which are ninth and tenth octets, wherein the home automation service reference number field is effective until a process of the message is completed;
a message type field to allocate message identification numbers to request and respond to control a home automation service, to search home automation data, to transfer data, to report status of service, and for automatic metering, home radio, and home data service; and
information parameter fields to store parameters to process messages and data for application service.

14. The system as recited in claim 13, wherein the information parameter fields include:
an information parameter identification (ID) for identifying home automation service information among other V5EF information parameters;
a length of information parameter field to show a size of HAS information parameter in octet;
a user port ID field to identify the ADSL terminal, wherein a size of the user port ID field is 4 octets and the user port ID field corresponds to a phone number of a subscriber; and
a status field to show status of port that is identified by the user port ID and operation information, including one or more of calling, disabled, not using, call processing, testing, allocating, or clearing of a time slot for a 64 Kbps clear channel.

15. A home automation communication method using advanced asymmetric digital subscriber line (ADSL), comprising:
providing a home automation service with a home automation communication server;
transmitting and receiving a home automation service control signal and data with home automation devices in wired or wireless communication mode using low rate signals and a home automation service channel module included in an ADSL terminal; and
multiplexing a home automation service control signal and data between the home automation service communication server and the home automation service channel module using a home automation multiplexing module included in an ADSL accessing unit.

16. The method as recited in claim 15, wherein the transmitting and receiving data step includes:
performing functions of a wireless home network and a wireless home automation interface;
performing functions of a wired home network and a wired home automation interface;
generating data having a home automation service message format based on message types and information parameters using a home automation service framer connected to a low rate processing unit of an ADSL termination unit;
transferring the data to the low rate processing unit;
extracting a message type and information parameter from data having home automation service message format received from the low rate processing unit;
receiving messages and information parameter from the home automation service framer with a home automation service agent; performing a home service process with the home automation service agent; and
transferring home automation service control signal and data to the wireless home automation service circuit and the wired home automation service circuit using the home automation service agent.

17. The method as recited in claim 15, wherein the multiplexing step includes:
receiving and transferring low rate data using a low rate frame accessing unit connected to a low rate processing unit of an ADSL termination unit-central (ATU-C);
performing a home automation service procedure with a home automation service processing unit connected to the home automation communication server; and
transmitting/receiving data with the home automation service channel module through the low rate frame accessing unit.

18. The method as recited in claim 15, wherein the transmitting and receiving data step includes transferring information for the home automation service in a home automation protocol message having:
flag fields which are first and last octets for showing start and end of V5 envelope function (V5EF) frame;
V5 data link address fields which are second/third octets and third/forth octets, wherein the second/third octets and third/forth octets are identically copied;
a protocol identifier field which is an eighth octet;
control fields which are sixth and seventh octets;
frame check sequence (FCS) fields in which n−1^{st} and n−2^{nd} octets are generated based on a link access procedure for Integrated Services Digital Network (ISDN) D channel (Link Access Protocol Channel-D (LAPD)) protocol standard;
home automation service reference number fields which are ninth and tenth octets, wherein the home automation service reference number field is effective until a process of the message is completed;
a message type field for allocating message identification numbers for requesting and responding to control a home automation service, searching home automation data, transferring data, reporting status of service, automatic metering, home radio and home data service; and
information parameter fields for storing parameters for processing messages and data for application service.

19. The method as recited in claim 18, wherein the information parameter fields include:
an information parameter identification (ID) for identifying home automation service information among other V5EF information parameters;
a length of information parameter field for showing a size of home automation service information parameter in octet;
a user port ID field for identifying ADSL terminal, wherein a size of the user port ID field is 4 octets and the user port ID field is corresponding to a phone number of a subscriber; and
a status field for showing status of port that is identified by the user port ID and operation information, e.g., calling, disabled, not using, call processing, testing and allocating/clearing of time slot for 64 Kbps clear channel.
a status field for showing status of port that is identified by the user port ID and operation information, e.g., calling, disabled, not using, call processing, testing and allocating/clearing of time slot for 64 Kbps clear channel.
